(19) United States
(12) Patent Application Publication
(10) Pub. No.: US 2003/0137126 A1
(43) Pub. Date: Jul. 24, 2003

(54) Driver controlled side-to-side movable vehicle hitch for trailer backing

(76) Inventors: Gerald Louis Reuter, Plattsburgh, NY (US); Robert Michael Pais, Sharon, MA (US); Dat Jeanot CaoBa, Plattsburgh, NY (US)

Correspondence Address: Gerald Louis Reuter, 35 Crescent Drive, Plattsburgh, NY, 12901, US

(21) Appl. No.: 10/329,969

(22) Filed: Dec. 27, 2002

Related U.S. Application Data
(60) Provisional application No. 60/348,501, filed on Jan. 16, 2002.

(51) Int. Cl. B60D 1/44

(52) U.S. Cl. 280/479.1

(57) ABSTRACT

A side-to-side movable hitch that includes a driver controlled 3-position “joy stick” or hand switch provides an enhanced pivoting point in order to steer a backing trailer.

The movable hitch generally resembles current hitches on automobiles, trucks, and other over the road motor vehicles except that the instant invention includes a motor operated movable trailer attachment to steer the trailer while backing. The movable hitch will reduce or eliminate the need for drivers to pull ahead in order to reorient the direction of a backing trailer that has veered from the driver's intended backing direction.

Options are described for the driver to view the hitch location by a display on a mirror. Also, a self-centering feature of the hitch engages when the vehicle is proceeding at greater than about 2 miles an hour in forward motion.

### BACKGROUND OF THE INVENTION

The invention described herein did not benefit from any Federal Research and Development program.

This application claims the benefit of U. S. Provisional Application Number 60/348,501 Filing Date Jan. 16, 2002

Backing a trailer with a tow vehicle requires experience and training to facilitate placing the trailer into a defined space. In limited space backing areas the tow vehicle may require pulling forward a number of times to reorient the pivot direction of the trailer. Pulling forward to reorient the pivot of the trailer is commonly referred to as a pull-ahead. Professional truck drivers typically can back trailers with no pull-aheads or more certainly with a limited number of pull-aheads.

Trailer backing is common at recreational vehicle sites, motor home parks, boat launch ramps, loading docks, and other defined space locations. In current practice, when backing a trailer, the direction that the steering wheels place on the tow vehicle pivots the hitch in order to steer the trailer in the desired direction.

The instant invention provides the driver with a side-to-side hitch movement to enhance and correct the pivot point of the tow vehicle in order to steer the backing trailer

The present invention relates generally to a side-to-side movable trailer hitch for an automobile, minivan, van, bus, truck tractor and any over-the-road motor vehicle that may be controlled by the driver to steer the trailer while backing.

### SUMMARY OF THE INVENTION

The present invention provides for a driver operated side-to-side movable trailer hitch mounted on an over-the-road motor vehicle to essentially steer the trailer while backing. In current practice the steering wheels of the tow vehicle pivots the hitch in order to orient the trailer's direction. In limited space docking locations the backing tow vehicle may need to stop and pull forward to reorient the pivot direction of the trailer. This is due to the limited pivoting angle that the tow vehicle has on the hitch. The instant invention provides for a greater pivoting of the receiver, thus, reducing, if not eliminating pull-aheads.

### BRIEF DESCRIPTION OF THE DRAWINGS

FIG. 1 is a perspective view from the top showing the major hitch components; Supports (1) for attaching the hitch to the tow vehicle, Motor (2) to operate the Jackscrew (3) that moves the Movable Block (4) and attached receiver within the Mount (5), Mount (5) that supports and contains the internal fixed and movable components and Receiver (6) that accommodates the attachment of the trailer.

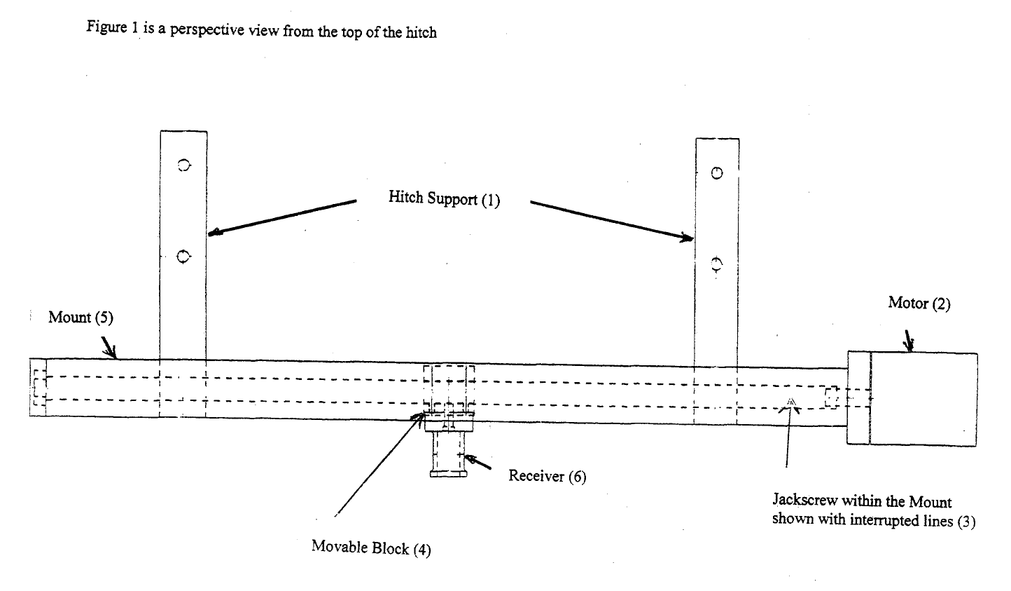

FIG. 2 is a perspective view from an end of the hitch (motor and spindle removed) showing the following components; Hitch support (1) for attachment to the tow vehicle, Mount (in region of the slot) (2) that supports and contains the movable block (3) and jackscrew (4), Movable block with mortise (shown by interrupted lines), Jackscrew and Receiver (shown as exploded view) (5).

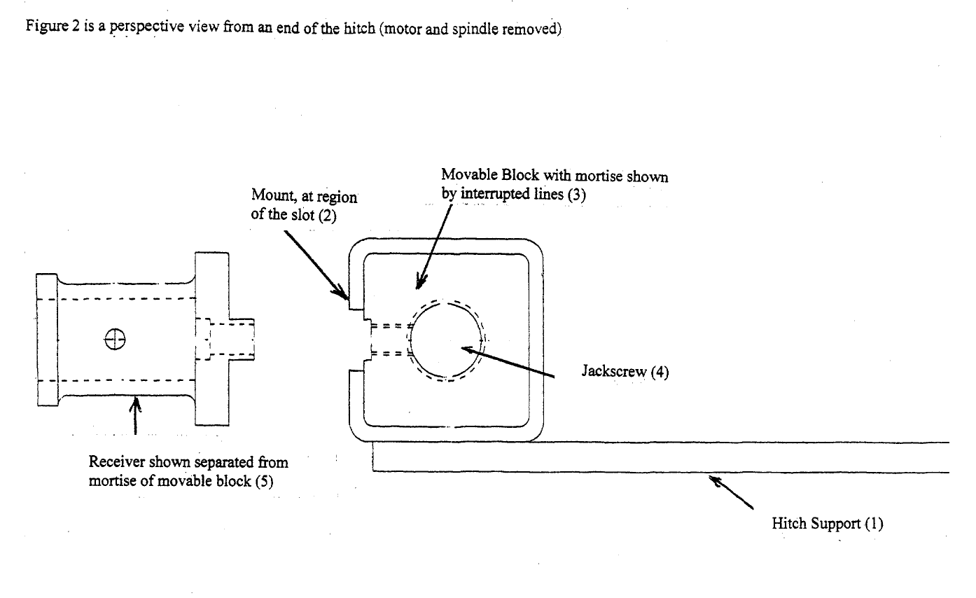

FIG. 3 is a perspective view of hitch showing the slot (1) in the mount (2) and the following components; Hitch supports (3), Mount (2), Movable receiver (4), End cap (in exploded view) (5), Spindle and Stepper Motor (in exploded view) (6).

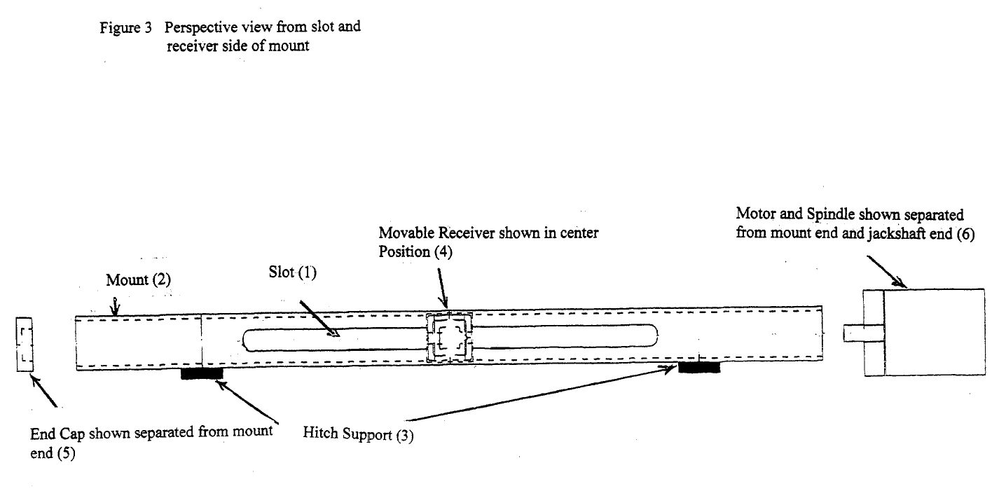

FIG. 4 shows an exploded view from the top of the hitch of the following major components (in line sequence from left to right); End cap and bearing (1), Mount (2), Hitch supports (3), Jackscrew (4), Movable block (5), Receiver (6), Spindle end bearing (7), Motor with spindle (8).

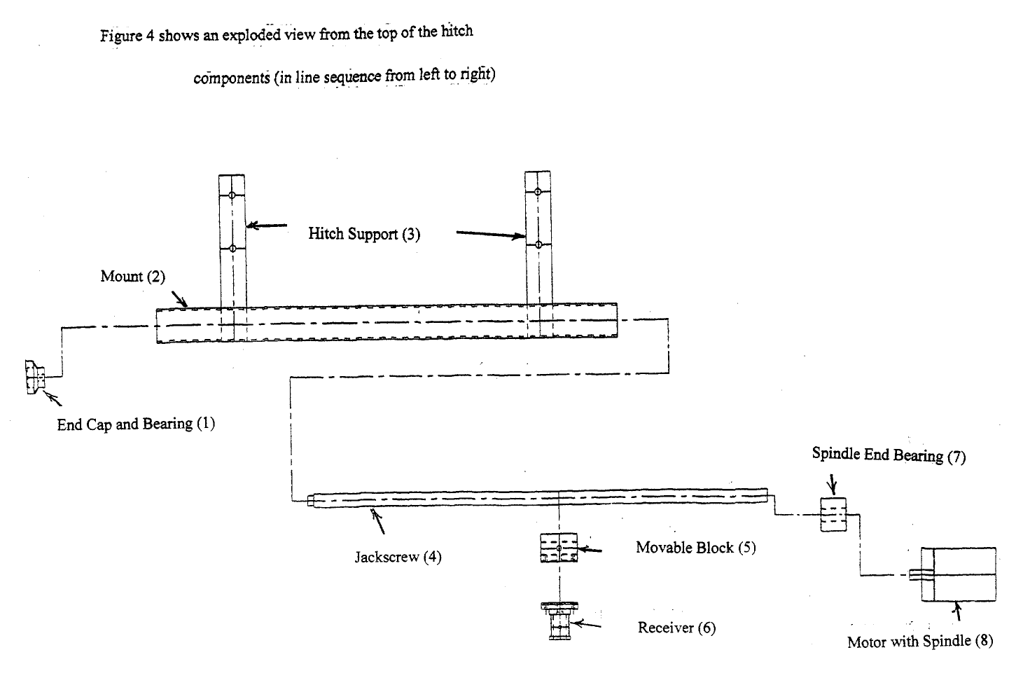

FIG. 5 depicts Vehicle A (with its hitch location in the center position) (2) when backing with steering wheels turned left (1) trailer will steer following Vector 1. When vehicle B (with its hitch location moved to left of center position) (4) when backing with steering wheels oriented straight ahead (3) shows that the superimposed trailer (shown by interrupted lines) will steer following Vector 2.

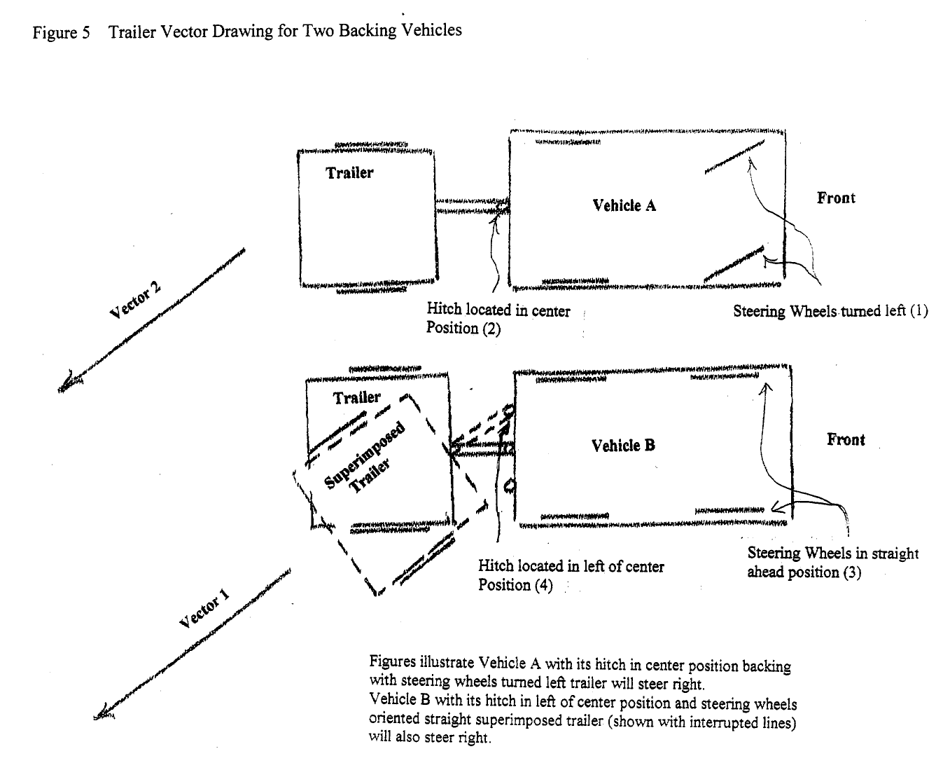

Depiction illustrates that the pivot point of the hitch is controlled either by the steering wheels of the backing tow vehicle or by the hitch that has been moved left of center.

The trailer of vehicle A and the superimposed trailer of vehicle B will be backing in the same direction even though vehicle A's pivot point is controlled by vehicle A's steering wheels and vehicle B's pivot point is solely controlled by vehicle B's side-to-side movable hitch that has been located left of center while backing.

### DETAILED DESCRIPTION OF PREFERRED EMBODIMENT

An example of a side-to-side movable receiver type hitch in the instant invention when attached to a tow vehicle is detailed. The hitch comprises a vehicle attached approximately 30-inch long square stock support mount, a jackscrew inside the mount that is secured by a bearing at one end of the mount and secured at the other end of the mount to a motor driven spindle, and a movable block connected through a slot on one side of the mount to the receiver.

The slot accommodates the side-to-side movement of the movable block and the attached receiver. The movable block is contained and supported within the mount and has a center threaded hole by which the jackscrew moves the block. The motor driven jackscrew thereby moves the threaded block and its attached receiver within the mount itself and not beyond the side end limits of the slot.

The tow vehicle driver operating a 3-position neutral center switch, controls the movement of the hitch. Pressing the one side of the switch moves the receiver left and pressing the other side of the switch moves the receiver right. Electric cutout or limit switches affixed near each end of the slot breaks the motor circuit for that direction so as to not overload the motor when a limit of the slot is approached. The circuit, to power the motor in the opposite direction, however, can be activated when the driver activates the switch to move the hitch in the opposite direction.

While backing the experienced driver commonly monitors the trailer's orientation by viewing the trailers directional progress in the tow vehicle's outside rear-view mirrors.

An optional gauge on the mirrors can identify the hitch location to the driver. The gauge which may, for example, employ light emitting diode indicators or an analog indicator that may be driven from a line transducer placed within the hitch mount.

Experienced professional drivers viewing the trailer's orientation in relation to the hitch location greatly facilitates the backing of the trailer. Furthermore, the hitch location indicator provides driver awareness as to the hitch location for over-the-road use.

An additional option provides for a self-centering receiver. Once forward motion of 2 to 5 miles per hour is detected the receiver would move to a preferred over-the-road center location.

The preferred embodiment for a receiver type hitch in the instant invention, as described above, does not exclude fifth wheel type hitches common to truck tractors. Although the receiver as described above may employ a ball, pintle, or hook type apparatus. A fifth wheel type movable hitch apparatus of the instant invention is described as follows..

The fifth-wheel type hitch may employ at least 2 jackscrews synchronized by chain, belt or gear to a single motor. A motor controlled 3-position neutral switch will move the fifth wheel apparatus left or right of center to steer the trailer while backing.

That which is claimed is;

1. A side-to-side movable trailer hitch mounted on a tow vehicle or truck tractor to steer or pivot the trailer during backing.

2. An apparatus according to claim 1 where the vehicle hitch is a receiver type that may be adapted to accommodate a ball, pintle or hook type attachment.

3. An apparatus according to claim 1 where the vehicle hitch is a fifth wheel type of attachment.

4. An apparatus according to claim 1 where the movement of the hitch is controlled by the driver to enhance the steering direction of the trailer independent or coincident with the pivoting influence of the steering wheel of the tow vehicle while backing.

5. An apparatus according to claim 1 where the hitch location or position is displayed by a light emitting indicator or analog indicator on the outside side view mirrors of the tow vehicle.

6. An apparatus according to claim 1 where the hitch location is displayed by an indicator on the dashboard of the tow vehicle employing a tractor-trailer intelligent communication and power link.

7. An apparatus according to claim 1 where the receiver or movable hitch automatically centers for over-the-road use when the tow vehicle achieves a forward speed of about 2 to 5 miles per hour.
